(19) United States
(12) Patent Application Publication
(10) Pub. No.: US 2019/0162971 A1
(43) Pub. Date: May 30, 2019

(54) APPARATUS AND METHOD FOR A HEAD BAND CONFIGURED FOR OUTWARD DISPLAY OF A MOBILE DEVICE

(71) Applicant: Judy Chien, New York, NY (US)

(72) Inventor: Judy Chien, New York, NY (US)

(21) Appl. No.: 15/827,537

(22) Filed: Nov. 30, 2017

(51) Int. Cl. G02B 27/01; G06F 3/041

(52) U.S. Cl. CPC G02B 27/0176; G02B 27/0172; G06F 3/0412

(57) ABSTRACT

In a preferred aspect of the invention, invention relates to a device-strapped head-band that comprises a circumferential-shaped band configured to stretch and fit over a head of any size. The band rests and conforms generally to a forehead of a first user (mounted user) and is disposed with opposable elastic straps, not affixed to the band, wherein the opposable straps are slidably disposed circumferentially in either direction over the band. As a result, the ring-like straps may move in either direction circumferentially over the head band. Additionally, each elastic strap is configured to stretch and conform tightly over any end of any mobile device with display. The freedom of movement of the straps, along with its elasticity, allows it to conform tightly over any number of mobile devices.

### BACKGROUND

### Field of the Invention

The present invention generally relates to a head band configured for outward or screen display of a mobile device. More particularly, the invention relates to an apparatus that provides adjustable straps to support the weight of a mobile device and allow for the display screen side to be exposed to a second user to allow the wearer of the head band to engage the second user hands-free.

### Related Art

With the ubiquity of mobile devices with sophisticated video capturing and video-playback technology, there has been a growing demand for mounting devices onto one's head for hands-free video capture or video playback. While most of the head-mounted devices are camera-facing, a few are configured for outward or screen display. However, these require a baseball-style cap, wherein the visor of the cap obstructs or interferes with the view of the display from the perspective of the second (engaged) user during close-proximity with the first (mounted) user. There are currently no head-mounted devices for outward display that are cap and visor free, and that allow for an unobstructed view of the display during hands-free, proximal engagement between a mounted and engaged user.

The importance of being cap and visor free, other than the fact that it will avoid obstruction or interference with the engaged user, is the fact that there are no risks of an engaged user from removing the cap from the mounted user. For instance, in situations where the mounted user is a parent attempting to distract the engaged user—in this case, a baby in need of a diaper change—the parent may display a distracting video and not fear the baby playing with the visor and dislodging the cap, or device.

The typical head wear configured for coupling a mobile device use a clip coupled to a cell phone mount. The clip slides onto the visor of a baseball cap and transforms the cell phone into a hands-free video cam. One such example is the Steamaroo Universal hands-Free Smartphone Hat Mount. The Steamaroo Hat Mount is intended for lengthy video capture of an event. Hatcam, much like Steamaroo, is a clip coupled to a cell phone mount, but has the added versatility of being able to flip the mount to below the visor, allowing the user to watch the recording in real-time. Both the Hatcam and Steamaroo are solely intended for long-duration video capture, and not for outward screen display.

The Cyclops hat is a cap disposed with an LCD screen for outward screen display. However, the LCD screen is a built-in screen, and not configured to accommodate for a users mobile device. Instead, the screen is fixed in place and streams video with an app on the users mobile device. Another similar device with a fixed LCD screens for outward display is the Live Lids smart hat. It is pre-loaded with twenty images or so of the users choosing. The hat would allow, for instance, a fan to switch team logos, or team affiliations, at the touch of a button. However, both Cyclops and Live Lids are disposed with a fixed screen and do not give the user the option to mount and un-mount their own mobile device.

Cellfy offers a cap-free, universal head mount operable with any device. It is mounted on the head by way of an elastic head strap that runs circumferentially around the head and has a single traversing strap over the head. The straps are elastic with a clip coupled to a mount disposed at the center of the forehead. The mobile device is further reinforced with a perpendicular strap that runs over the middle of the device. The Cellfy is also intended for long-duration, hands-free video capture—and not screen-facing or outward display, as evidenced by the perpendicular reinforcing strap, which would obstruct the screen if the mount or mobile device was flipped.

U.S. patent—Head Mount Apparatus for Hands-Free Recording with an Electronic Device (U.S. Pat. No. 9,038,870)—granted to August A. Johnson claims and describes a strapped head mount operable with any number of devices. Johnson claims and describes a head mount with a mounting plate coupled to a retention strap and a head strap. As in Cellfy, Johnson's inclusion of a retention strap to reinforce the mobile device onto the mounting plate would obstruct the display if the phone or mount were flipped. As a result, it can be conclusively surmised that Johnson is also intended for long-duration video capture, and not intended for a head mount operable for outward display.

Thus, there is a need for an adjustable, portable, compact and customizable head band with adjustable straps configured for mounting a mobile device for display towards an engaged user during close proximity with a mounted user. There is a need for such a head mount, lacking any one of a visor, clip, mount, fixed LCD display, retention straps, or mounting plate, which poses risks of display obstruction or being interfered with by the engaged user. For instance, a baby during a diaper change needs to be engaged with distracting video playback, while allowing the parent to be hands-free for convenience. The parent shouldn't have to worry about the baby removing the cap by tugging at the visor, nor should the baby have to look over a visor or stare at a reinforcing strap running through the middle of a display.

### SUMMARY

The embodiments of the present invention relate to a head band disposed with elastic straps configured for outward display of a mobile device, and more specifically, the embodiments of the present invention relate to distracting an engaged user (baby) during feeding or diaper change with video playback, while allowing the mounted user (parent) to be hands-free for convenience.

In general, one aspect of the invention relates to a device-strapped head-band that comprises a circumferential-shaped band configured to stretch and fit over a head of any size. The band rests and conforms generally to a forehead of a first user (mounted user) and is disposed with opposable elastic straps, not affixed to the band, wherein the opposable straps are slidably disposed circumferentially in either direction over the band. As a result, the ring-like straps may move in either direction circumferentially over the head band. Additionally, each elastic strap is configured to stretch and conform tightly over any end of any mobile device with display. The freedom of movement of the straps, along with its elasticity, allows it to conform tightly over any number of mobile devices.

In the same aspect, the mobile device display is securely rested over the forehead of the first user (mounted user) and the display is positioned at a center of the first users (mounted users) forehead. As such, the totality of the screen is unobstructed by the opposable elastic straps, and orientated toward a second user (engaged user) during engagement with the second user (engaged user). The lack of cap and visor allows for increased exposure of the display and closer proximity to the engaged user. More importantly, there is no risk of the engaged user from tugging at the visor and dislodging the cap or mobile device. The lack of a mounting plate or reinforcing straps running over the head of the mounted user provides for additional comfort and freedom.

The mounted user can further stretch the mobile device straps until it is contoured to securely fix the mobile device in place. The weight of the mobile device will not present any risks of falling from the head band due to the tight fit of the straps over the ends of the mobile device. Moreover, the band may be re-positioned on the forehead in order to deliver a varying vantage point for the engaged user.

The device has multiple uses in the fields of travel, patient care, child care, etc. The device may be applicable for any scenario which calls for engaging and distracting an engaged user by another user (mounted user). The mounted user may engage and distract the engaged user with video playback, still images, and, or any content capable of being delivered by one's mobile device. By securely fixing the mobile device on one's head, the mounted user is hands-free to undergo various daily tasks, such as changing a diaper, feeding a baby, administering treatment to an elderly, etc.

As another object of the invention, the elastic straps may be affixed to the head band, disabling the straps from moving around the band. This embodiment relates to a device-strapped head-band comprising: a circumferential-shaped band configured to stretch and fit over a head of any size, said band resting and conforming generally to a forehead of a first user. The opposable elastic straps have a back surface of affixed to a front surface of the band. The opposable straps generally being a mobile device-length apart in distance.

In such an embodiment, the elastic straps are configured to stretch and conform tightly over any end of specific mobile device with display, but are a fixed distance apart. The advantage of the affixed straps may be that the mobile device is further secured in place, while the disadvantage may be that the full array of mobile devices may not be accommodated for.

As in the ring-strap embodiment, the fixed-strap embodiment may prominently feature the mobile device display by having it securely rested over the forehead of the first user. The display is positioned at a center of the first users (mounted users) forehead and orientated toward a second user (engaged user) during engagement with the second user (engaged user).

In yet another object of the invention, a method of manufacturing is provided.

Other devices, apparatus, and/or products according to embodiments will be or will become apparent to one of ordinary skill in the art upon review of the following drawings and further description. It is intended that all such additional devices, apparatus, and/or products be included within this description, be within the scope of the present invention, and be protected by the accompanying claims.

### BRIEF DESCRIPTION OF THE DRAWINGS

FIG. 1a shows a front perspective view diagram according to aspects of the invention.

FIG. 1b shows a top elevation view diagram according to aspects of the invention.

FIG. 2 shows a front perspective view housing a mobile device according to aspects of the invention.

FIG. 3a shows a front perspective view housing a mobile device fit over a user according to aspects of the invention.

FIG. 3b shows a front perspective view housing a mobile device fit over a user during engagement according to aspects of the invention.

### DETAILED DESCRIPTION

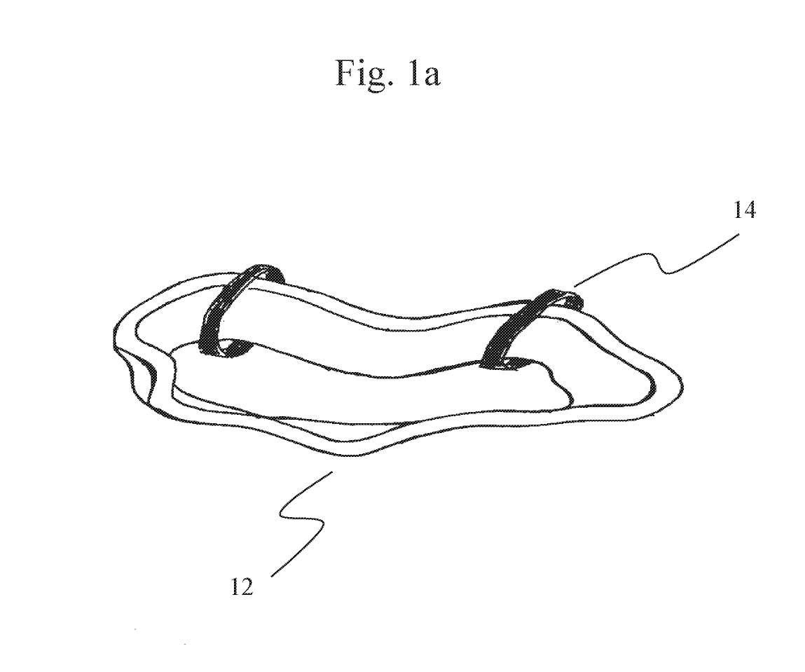

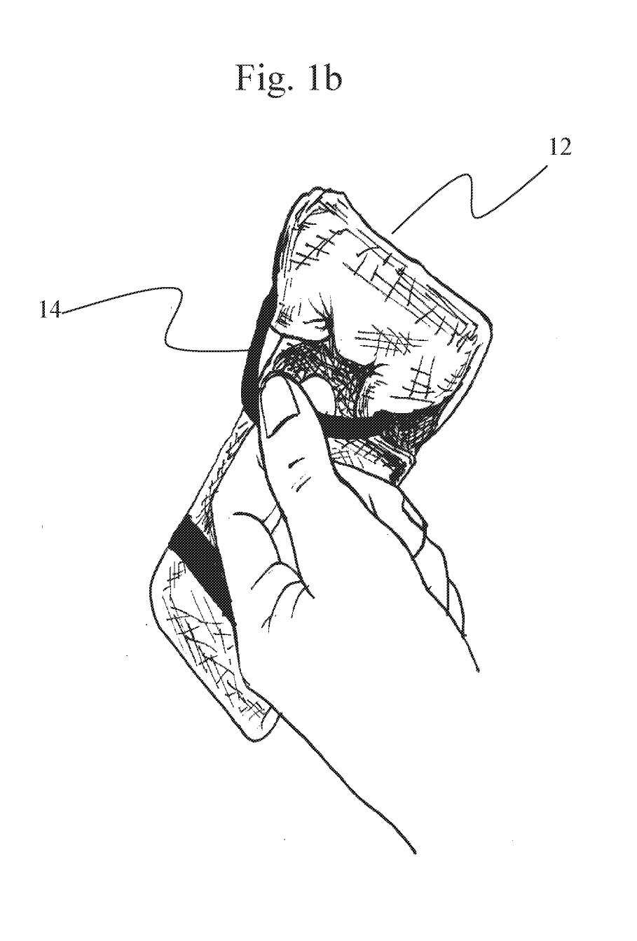

The following is a discussion and description of preferred specific embodiments of the head and neck support device as claimed, such being made with reference to drawings, and in particular to FIGS. 1 to 3 thereof, whereupon the same reference numerals are used to indicate the same or similar parts and/or structure. Such discussion and description is to illustrate and not to unduly limit the scope of the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Referring to the drawings in detail and particularly to FIGS. 1a and 1b, the head and neck support device is shown in a perspective and elevation views. FIGS. 1a and 1b show one of many embodiments that have been conceived by the inventor. Now in reference to FIG. 1a, in its normal usage as a device-strapped head band, the user may manipulate the position of the untethered straps 14 revolved over the head band portion 12 in order to accommodate a mobile device of any size. The advantage of this is that the engaged user will be exposed to a full display, without the encumbrance of straps 14 and display occlusion. Moreover, the lack of an elaborate assembly (mounting plate and reinforcement straps) allows for mounted users to easily mount and un-mount the mobile device from the head band 12. The apparatus, as shown in FIG. 1a and FIG. 1b, may comprise of a head band portion 12 of a unitary construction, including a terry cloth, elastic strap, pliable foam and, or sheath encased. In a preferred embodiment, the head band portion is terry cloth with sufficient elasticity to fit over a head of any size, along with supporting the weight of any mobile device. The straps 14 should also have sufficient elasticity to fit over a mobile device of any size and securely position said mobile device in place over the forehead of the mounted user. Straps 14 may be any one of, or combination of, durable materials, such as, polyester, nylon, latex, latex-free, and, or cotton. The individual straps 14 may be braided, knitted, or woven. They may each have a stretch value of at least 125%.

The strapped head band apparatus may be compatible with most majority bands of smartphone, such as iPhone 7/7 Plus, Samsung Galaxy S8 S7 S6, Note 5/4/3, HTC ONE, LG, Sony Xperia, Google Nexus Pixel and other phones with a screen size below or larger 6.3 inches. Ideally, the mobile device may have a screen size of 6.3 inches, Additionally, with minor manipulation of the head band 12 or straps 14, the mounted user may easily angle the phone towards the engaged user, providing for a perfect frontal line of sight of the display.

Now in reference to FIG. 1b, a top elevation view of the strapped head band in accordance with an aspect of the invention is shown. In a preferred aspect of the invention, invention relates to a device-strapped head-band that comprises a circumferential-shaped band 12 configured to stretch and fit over a head of any size. The band 12 rests and conforms generally to a forehead of a first user (mounted user) and is disposed with opposable elastic straps 14, not affixed to the band, wherein the opposable straps 14 are slidably disposed circumferentially in either direction over the band 12. As a result, the ring-like straps 14 may move in either direction circumferentially over the head band. Additionally, each elastic strap 14 is configured to stretch and conform tightly over any end of any mobile device with display. The freedom of movement of the straps 14, along with its elasticity, allows it to conform tightly over any number of mobile devices. In a preferred embodiment, the straps 14 are composed of any one of, or combination of, cotton, nylon, polyester, latex, latex-free and may be woven, braided, and, or knitted. The straps 14 may be elastic enough to securely fit and support the weight of any number of smart phones—while allowing for a full frontal line of sight of the display from the vantage of the engaged user.

In the same aspect, the mobile device display is securely rested over the forehead of the first user (mounted user) and the display is positioned at a center of the first users (mounted users) forehead. As such, the totality of the screen is unobstructed by the opposable elastic straps 14, and orientated toward a second user (engaged user) during engagement with the second user (engaged user). The lack of cap and visor allows for increased exposure of the display and closer proximity to the engaged user. More importantly, there is no risk of the engaged user from tugging at the visor and dislodging the cap or mobile device. The lack of a mounting plate or reinforcing straps running over the head of the mounted user provides for additional comfort and freedom. Additionally, the mounted user may easily manipulate the head band 12 and, or strap 14 to further angle the phone display for a more optimal line of sight, depending on the position and proximity of the engaged user. For instance, during a diaper change, a parent may want to tilt the head band 12 upwards, since the head of the parent is already positioned downwards. Conversely, the parent may want to not tilt the head band 12, especially when the parent and child may be eye-level with one another, such as during a feeding.

While not shown in FIG. 1b, a head band 12 may further be reinforced in order to support the weight of larger and heavier devices. In such an embodiment, a rubber or foam band encased in a comfortable sheathing may be provided. The sheathing may be any one of, or combination of, cloth, textile, fabric, and, or any other flexible material, for example, nylon and or spandex sheathing. The encased foam material may be any one of a pliable and, or elastomeric material, conforming to the shape of the mounted user. The inner foam may be a made of any one of, or combination of heat-settable thermoplastic material and, or polymer with high tensile, medium pliable, and “memory”.

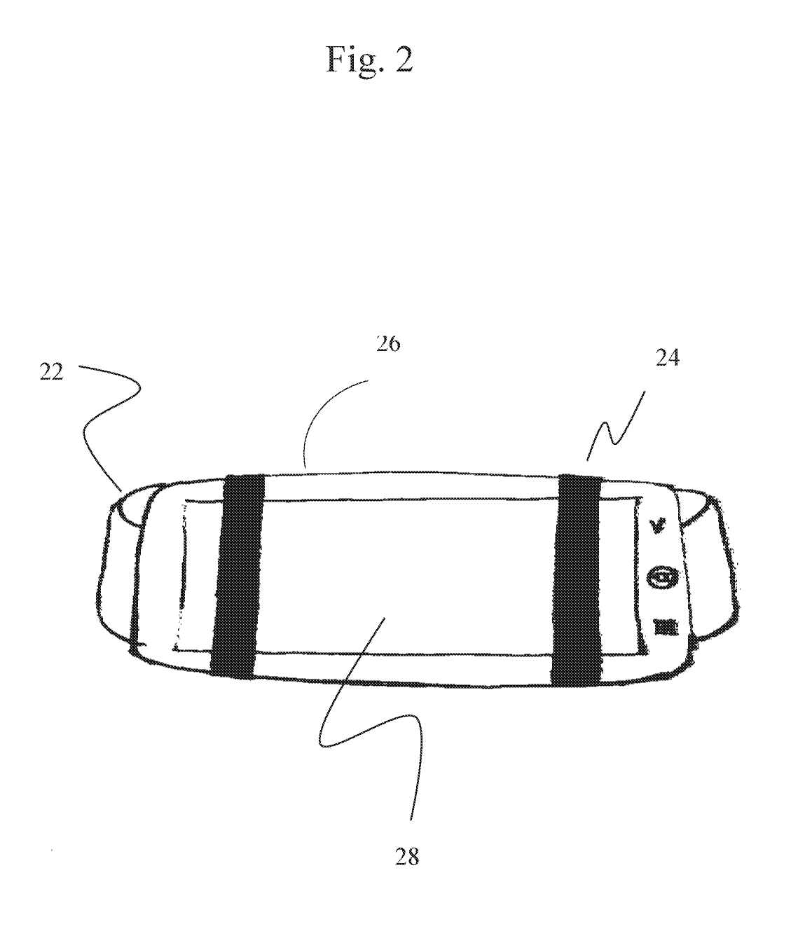

FIG. 2 illustrates a front perspective view housing a mobile device according to aspects of the invention. In its normal usage as a device-strapped head band, the user may manipulate the position of the untethered straps 24 revolved over the head band portion 22 in order to accommodate a mobile device 26 of any size. The advantage of this is that the engaged user will be exposed to a full display 28, without the encumbrance of straps 24 and display occlusion. Moreover, the lack of an elaborate assembly (mounting plate and reinforcement straps) allows for mounted users to easily mount and un-mount the mobile device 26 from the head band 22.

In another embodiment, the straps 24 may be affixed to the head band portion 22, allowing for a more secure fitting of specific sized mobile devices 26. The strap-affixed embodiment may comprise a circumferential-shaped band 22 configured to stretch and fit over a head of any size, with the band 22 resting and conforming generally to a forehead of a first user. Furthermore, the opposable elastic straps 24, wherein the back surface of the straps 24 are affixed to a front surface of the band 22, and the opposable straps 24 are generally a mobile device-length apart in distance. Each elastic strap 22 may be configured to stretch and conform tightly over any end of any mobile device 26 with display 28. The mobile device display 28 is securely rested over the forehead of the first user and the display 28 is positioned at a center of the first users forehead and orientated toward a second user during engagement with the second user.

While not shown in FIG. 2, the head-band device may comprise an element projecting from an outer surface of the band, and may be configured for dangling over the second user during engagement with the second user. The element may be fabricated from the same material as the band, formed seamlessly and coextensively with the band. Conversely, the element may be a different material as the band, affixed during or after manufacturing of the band. Additionally, the element may be a molded and, or free-stranded mock hair projecting from a top edge of the band. In a preferred embodiment, the head-band device may feature a novelty design element, which may be a protrusion mimicking the dorsal appendages of fish and other animals, i.e. shark fins, etc. The protrusion in this particular embodiment may be disposed on a top, front, or sides of the head band portion. Other embodiments cover any and all other novelty design features, which may be distracting to children, including, but not limited to, animated characters, copyrighted characters requiring licensing arrangements, i.e., Disney-themed characters, etc. These elements may also be disposed on a top, front, or sides of the head band portion.

In yet another alternative embodiment, also not shown, an elasticized or drawstring band may be circumferentially housed within the head band portion. The terminal ends may be exposed through eyelets disposed on the front or side of the head band portion. Pulling and tying each end together may allow for tighter and more secure fit of the head band portion over the head of a mounted user. The drawstring may additionally be drawn or undrawn using a draw cord closure mechanism. All of the above mentioned mechanisms allow the embodiment to securely fit over a mounted users head of any size, and support the weight of any mobile device.

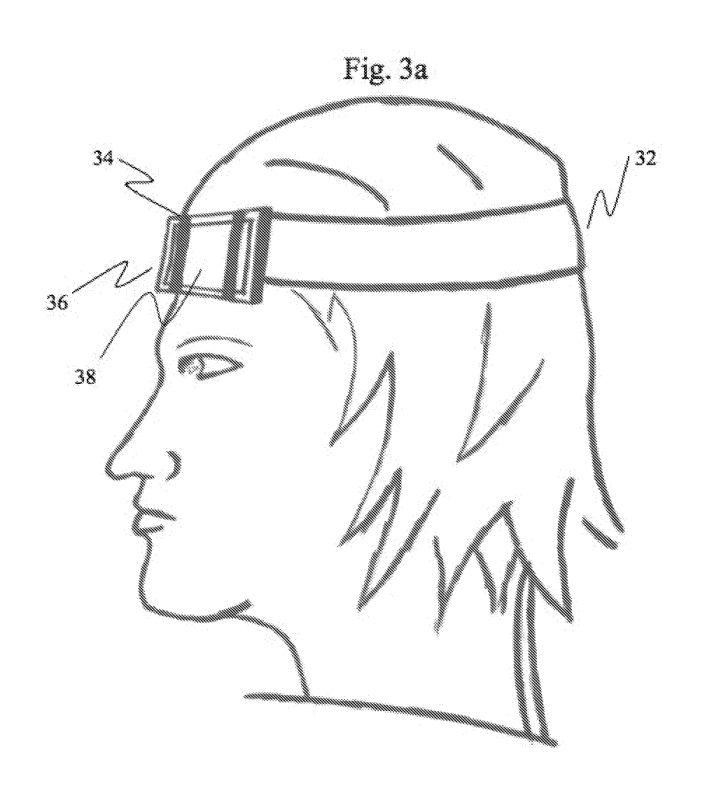

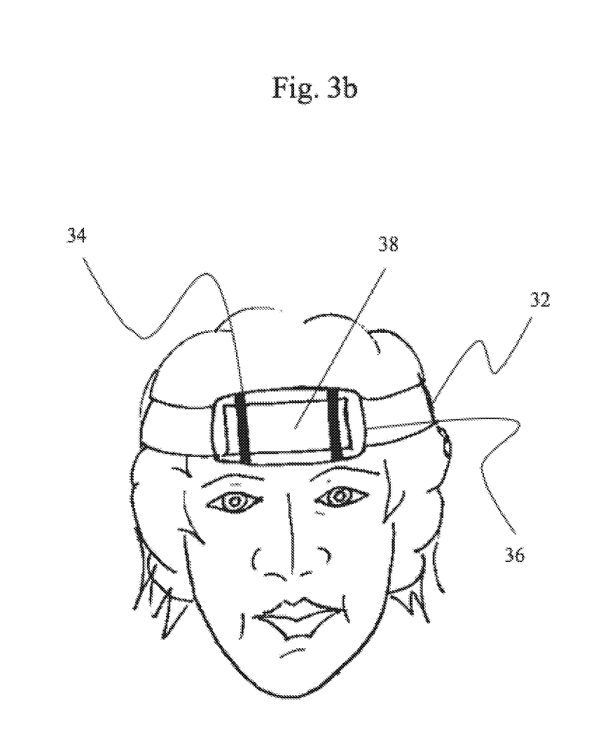

FIG. 3a and FIG. 3b illustrate two different vantage points of the device housing a mobile device and fit over a user. FIG. 3a illustrates a close-up front perspective of the device housing a mobile device and fit over a user. On the other hand, FIG. 3b illustrates a zoomed-out front perspective of the device housing a mobile device and fit over a user during engagement. As seen in FIGS. 3a and 3b, the mobile device display 38 is securely rested over the forehead of the first user (mounted user) 35 and the display 38 is positioned at a center of the first users (mounted users) 35 forehead. As such, the totality of the screen 38 is unobstructed by the opposable elastic straps 34, and orientated toward a second user (engaged user) 37 during engagement with the second user (engaged user) 37. The lack of cap and visor allows for increased exposure of the display 38 and closer proximity to the engaged user 37. More importantly, there is no risk of the engaged user 37 from tugging at the visor and dislodging the cap or mobile device 36. The lack of a mounting plate or reinforcing straps running over the head of the mounted user 35 provides for additional comfort and freedom.

The mounted user 35 can further stretch the mobile device straps 34 until it is contoured to securely fix the mobile device 36 in place. The weight of the mobile device 36 will not present any risks of falling from the head band 32 due to the tight fit of the straps 34 over the ends of the mobile device 36. Moreover, the band 32 may be re-positioned on the forehead in order to deliver a varying vantage point for the engaged user 37.

The mounted user 35 may manipulate the position of the tethered or untethered straps 44 revolved, affixed over the head band portion 32 in order to accommodate a mobile device 36 of any size. The advantage of this is that the engaged user 35 will be exposed to a full display 38, without the encumbrance of straps 34 and display 38 occlusion. Moreover, the lack of an elaborate assembly (mounting plate and reinforcement straps) allows for mounted users 35 to easily mount and un-mount the mobile device 36 from the head band 32.

The apparatus, as shown in FIG. 3a and FIG. 3b, may comprise of a head band portion 32 of a unitary construction, including a terry cloth, elastic strap, pliable foam and, or sheath encased. In a preferred embodiment, the head band portion 32 is terry cloth with sufficient elasticity to fit over a head of any size, along with supporting the weight of any mobile device 36. The straps 34 should also have sufficient elasticity to fit over a mobile device 36 of any size and securely position said mobile device in place over the forehead of the mounted user 35. Furthermore, the straps 34 may be any one of, or combination of, durable materials, such as, polyester, nylon, latex, latex-free, and, or cotton. The individual straps 34 additionally may be braided, knitted, or woven.

While not shown in FIG. 3a or 3b, in one potential embodiment, the circumferential-shaped band may be configured to stretch and fit over a head of any size, and rest/conform generally to a forehead of a first user. Furthermore, the band may comprise opposable elastic straps, wherein the back surface of said straps may be affixed to a front surface of the band via an adhesive fabric fastener. The fastener-coupled opposable elastic straps may be configured to stretch and conform tightly over any point of any mobile device with display. As a result, the mobile device display may be securely rested over the forehead of the first user and positioned over the forehead at a choosing of the first user and orientated toward a second user during engagement with the second user.

Also not shown in FIG. 3a or 3b is an embodiment wherein the band does or does not comprise straps—affixed or not affixed—and the mobile device, instead, secures on the band by way of opposable inserts cut through on the forehead portion of the front surface of the head band. The user would simply insert each end of the mobile device into each insert disposed on the forehead portion of the front surface of the head band. In some embodiments, the head band may comprise both the opposable straps and the opposable inserts, giving the user the option of strapping the device secure or inserting the device secure. The straps may be the entire length of the width of the band, or may be smaller, since the band or inserts may expand to conform to the size and shape of the device. The inserts may be spaced apart a standard mobile device-length apart or the same distance the affixed opposable straps are apart from one another.

Also not shown in FIG. 3a or 3b is an embodiment wherein the band does or does not comprise straps—affixed or not affixed—and the mobile device, instead, secures on the band by way of a see-through sleeve configured to house a mobile device, said sleeve affixed to a front surface of said band, wherein at least a single side of said sleeve is entirely open to slip in said device. The user would simply insert the mobile device into the at least single side of the sleeve that is open. In some embodiments, the head band may comprise both the opposable straps and, or the opposable inserts, and, or the sleeve, giving the user the option of strapping the device secure, inserting the device secure, or slipping the device secure. The straps may be the entire length of the width of the band, or may be smaller, since the band or inserts may expand to conform to the size and shape of the device. The see-through sleeve may be the size of a standard mobile device or larger than the standard mobile device.

As a result, the mobile device display is securely rested over the forehead of a first user and said display is positioned at a center of the first users forehead, unobstructed by the opposable straps, and orientated toward a second user during engagement with the second user.

In other embodiments, a method of manufacturing may describe steps for sewing the opposable elastic straps onto the head-band, such that the straps are affixed to the head-band, rather than being slidably disposed over the circumference of the head band. In yet other embodiments, the straps may be disposed on a back surface with a fabric adhesive fastener portion to allow affixing onto the complementary fabric adhesive fastener portion running at least the length of the front-facing portion of the head band.

In other embodiments, rather than the terry cloth head-band, a more rigid internal crux may be used to affix the straps onto. The crux may be composed of any one of, or a combination of, a soft, moldable, flexible, stretchable, temper or plastic alloy. Further yet, in another embodiment, the internal crux may be encased by a sheathing of any one or a combination of foam or foam beads made of either any one of, or a combination of, polystyrene or polyurethane. The foam or the foam beads can be homogeneously or heterogeneously distributed throughout the head band portion.

The foam or foam beads and the internal crux may be further stitched and encased in any one of or a combination of cloth, terry cloth, textile material, casing, sheath, fabric, padding or any other flexible material, for example, nylon and or spandex sheathing. The stitching may be done using similar color thread as the color of the material used or contrasting colored threads depending on the preference of the customer. The preferred embodiment incorporating the encasing material used for the head-band device could be of varying colors, patterns and styles including, but not limited to, animated characters, sports teams, college teams, company logos, school and university logos etc.

The head-band device as described in the current application can be manufactured using several different techniques. The device can be given a personalized touch by hand-making and stitching an individual piece, according to the client's desire and wish or can be mass produced in a industrial unit setting to cater to an economical buyer.

Therefore, the foregoing is considered as illustrative and descriptive of a number of embodiments covering the novel aspects of the head and neck device, and it is not intended to be limited to the details shown, since various modifications and structural changes may be made without departing in any way from the spirit of the present invention.

While this specification contains many specific execution details, these should not be interpreted as limitations on the scope of any inventions or of what may be claimed, but rather as descriptions of features specific to particular embodiments of particular inventions. Certain features that are described in this specification in the context of separate embodiments can also be implemented in combination in a single embodiment. Contrariwise, various features that are described in the context of a single embodiment can also be implemented and interpreted in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A device-strapped head-band, said head-band comprising:
a circumferential-shaped band configured to stretch and fit over a head of any size, said band resting and conforming generally to a forehead of a first user;
opposable elastic straps, not affixed to the band, and said opposable straps slidably disposed circumferentially in either direction over the band;
each elastic strap configured to stretch and conform tightly over any end of any mobile device with display; and
wherein the mobile device display is securely rested over the forehead of the first user and said display is positioned at a center of the first users forehead, unobstructed by the opposable elastic straps, and orientated toward a second user during engagement with the second user.

2. The head-band of claim 1,
further comprising an element projecting from an outer surface of the band configured for dangling over the second user during engagement with the second user.

3. The head-band of claim 2,
wherein the element is fabricated from the same material as the band, formed seamlessly and coextensively with the band.

4. The head-band of claim 2,
wherein the element is a different material as the band, affixed during or after manufacturing of the band.

5. The head-band of claim 4,
wherein the element is a molded and, or free-stranded mock hair projecting from a top edge of the band.

6. The head-band of claim 2,
wherein the element mimics the appendages and, or other features of an any one of an animal.

7. The head-band of claim 2,
wherein the element may be any one of an animated character, feature of an animated character, and, or printed graphics related to an animated character and, or a feature of an animated character.

8. The head-band of claim 1,
wherein the circumferential-shaped band is a sweat-absorbent head-band generally used for absorbing sweat from a user's hair and, or forehead during physically strenuous activity.

9. The head-band of claim 1,
wherein the mobile device may be any one of mobile device with a display, such as a mobile phone, tablet, and, or electronic reader.

10. A device-strapped head-band, said head-band comprising:
a circumferential-shaped band configured to stretch and fit over a head of any size, said band resting and conforming generally to a forehead of a first user;
opposable elastic straps, a back surface of said straps affixed to a front surface of the band, and said opposable straps generally a mobile device-length apart in distance;
each elastic strap configured to stretch and conform tightly over any end of any mobile device with display; and
wherein the mobile device display is securely rested over the forehead of the first user and said display is positioned at a center of the first users forehead and orientated toward a second user during engagement with the second user.

11. The head-band of claim 10,
further comprising an element projecting from an outer surface of the band configured for dangling over the second user during engagement with the second user.

12. The head-band of claim 11,
wherein the element is fabricated from the same material as the band, formed seamlessly and coextensively with the band.

13. The head-band of claim 11,
wherein the element is a different material as the band, affixed during or after manufacturing of the band.

14. The head-band of claim 13,
wherein the element is a molded and, or free-stranded mock hair projecting from a top edge of the band.

15. The head-band of claim 11,
wherein the element mimics the appendages and, or other features of an any one of an animal.

16. The head-band of claim 11,
wherein the element may be any one of an animated character, feature of an animated character, and, or printed graphics related to an animated character and, or a feature of an animated character.

17. The head-band of claim 10,
wherein the circumferential-shaped band is a sweat-absorbent head-band generally used for absorbing sweat from a user's hair and, or forehead during physically strenuous activity.

18. The head-band of claim 10,
wherein the mobile device may be any one of mobile device with a display, such as a mobile phone, tablet, and, or electronic reader.

19. A device-strapped head-band, said head-band comprising:
a circumferential-shaped band configured to stretch and fit over a head of any size, said band resting and conforming generally to a forehead of a first user; opposable elastic straps, a back surface of said straps affixed to a front surface of the band via an adhesive fabric fastener, and said opposable elastic straps configured to stretch and conform tightly over any point of any mobile device with display; and
wherein the mobile device display is securely rested over the forehead of the first user and said display is positioned over the forehead at a choosing of the first user and orientated toward a second user during engagement with the second user.

20. The head-band of claim 19,
further comprising an element projecting from an outer surface of the band configured for dangling over the second user during engagement with the second user.

21. The head-band of claim 20,
wherein the element is fabricated from the same material as the band, formed seamlessly and coextensively with the band.

22. The head-band of claim 20,
wherein the element is a different material as the band, affixed during or after manufacturing of the band.

23. The head-band of claim 22,
wherein the element is a molded and, or free-stranded mock hair projecting from a top edge of the band.

24. The head-band of claim 20,
wherein the element mimics the appendages and, or other features of an any one of an animal.

25. The head-band of claim 20,
wherein the element may be any one of an animated character, feature of an animated character, and, or printed graphics related to an animated character and, or a feature of an animated character.

26. The head-band of claim 19,
wherein the circumferential-shaped band is a sweat-absorbent head-band generally used for absorbing sweat from a user's hair and, or forehead during physically strenuous activity.

27. The head-band of claim 19,
wherein the mobile device may be any one of mobile device with a display, such as a mobile phone, tablet, and, or electronic reader.

28. A device-strapped head-band, said head-band comprising:
a circumferential-shaped band configured to stretch and fit over a head of any size, said band resting and conforming generally to a forehead of a first user;
a see-through sleeve configured to house a mobile device, said sleeve affixed to a front surface of said band, wherein at least a single side of said sleeve is entirely open to slip in said device; and
wherein the mobile device display is securely rested over the forehead of the first user and said display is positioned over the forehead and orientated toward a second user during engagement with the second user.

29. A method of manufacturing a device-strapped head-band, said method comprising the steps of:
measuring two elastic straps with equal length and width to circumferentially wrap around a head band with sufficient space between the strap and band in order for the straps, opposable and un-affixed, to slide in any direction along the circumference of the head band; and
sewing the loose ends of each strap creating sufficient tensile strength to elongate upon a draw to fit tight over a mobile device, and to restore back to a normal state upon an un-draw from removing the mobile device from the opposable straps.
